(19) United States
(12) Patent Application Publication
(10) Pub. No.: US 2023/0275753 A1
(43) Pub. Date: Aug. 31, 2023

(54) CRYPTOGRAPHIC OPERATION APPARATUS AND METHOD USING QUANTUM CIRCUIT

(71) Applicant: ELECTRONICS AND TELECOMMUNICATIONS RESEARCH INSTITUTE, Daejeon (KR)

(72) Inventor: You-Seok LEE, Daejeon (KR)

(21) Appl. No.: 18/063,199

(22) Filed: Dec. 8, 2022

(30) Foreign Application Priority Data
Feb. 28, 2022 (KR) 10-2022-0026206

(51) Int. Cl. H04L 9/08; G06N 10/20

(52) U.S. Cl. CPC H04L 9/0852; G06N 10/20

(57) ABSTRACT

Disclosed herein are a cryptographic operation apparatus and method using a quantum circuit. The cryptographic operation apparatus includes one or more processors, and execution memory configured to store at least one program executed by the one or more processors, wherein the processors are configured to allocate input data corresponding to a finite field for calculating a substitution box to qubits, perform a field transformation on the input data allocated to the qubits from a finite field into data qubits corresponding to a composite field, set auxiliary qubits corresponding to the data qubits, calculate a multiplicative inverse for the data qubits using the data qubits and the auxiliary qubits, perform a field inverse transformation on a result of calculation of the multiplicative inverse into a finite field, and output a result of calculation of the substation box from a result of calculation of the field inverse transformation through affine transformation.

### CROSS REFERENCE TO RELATED APPLICATION

This application claims the benefit of Korean Patent Application No. 10-2022-0026206, filed Feb. 28, 2022, which is hereby incorporated by reference in its entirety into this application.

### BACKGROUND OF THE DISCLOSURE

### 1. Technical Field

The present disclosure relates generally to encryption algorithm technology, and more particularly to technology for implementing an encryption algorithm using a quantum circuit.

### 2. Description of the Related Art

In order to apply a quantum computation algorithm to an Advanced Encryption Standard (AES), an AES algorithm must be implemented using a quantum circuit.

One exerting the biggest influence on the efficiency of the quantum circuit, among fourth operations constituting the AES, is a substitution box (S-box) calculation process.

A substitution box (S-box) is one basic packet in cryptography fields, and a function thereof enables nonlinear substitution for data to be realized. In encryption algorithm technology, an S-box is the basic component of a symmetric key algorithm for performing substitution.

The efficiency of a quantum circuit may be determined depending on the number of qubits used for circuit configuration and the depth of a T-gate (T-depth).

Meanwhile, Korean Patent No. 10-2214836 entitled “Efficient Quantum Modular Multiplier and Method of Quantum Modular Multiplication” discloses a quantum modular multiplier and a quantum modular multiplication method, which may improve efficiency and decrease the complexity of a quantum circuit by utilizing the characteristics of a modular 2N−1 operation.

### SUMMARY OF THE DISCLOSURE

Accordingly, the present disclosure has been made keeping in mind the above problems occurring in the prior art, and an object of the present disclosure is to implement a quantum circuit that uses fewer qubits to apply a quantum computation algorithm to an AES.

Another object of the present disclosure is to reduce quantum resources required for a cryptographic operation using fewer qubits.

In accordance with an aspect of the present disclosure to accomplish the above objects, there is provided a cryptographic operation apparatus using a quantum circuit, including one or more processors; and an execution memory configured to store at least one program that is executed by the one or more processors, wherein the one or more processors are configured to allocate input data corresponding to a finite field for calculating a substitution box to qubits, perform a field transformation on the input data allocated to the qubits from a finite field into data qubits corresponding to a composite field, set auxiliary qubits corresponding to the data qubits, calculate a multiplicative inverse for the data qubits using the data qubits and the auxiliary qubits, perform a field inverse transformation on a result of calculation of the multiplicative inverse into a finite field, and output a result of calculation of the substation box from a result of calculation of the field inverse transformation through affine transformation.

The one or more processors may be configured to perform the field transformation on the finite field into the composite field by multiplying a determinant corresponding to the finite field by a preset field transformation determinant.

The one or more processors may be configured to initialize remaining auxiliary qubits, other than output qubits, among auxiliary qubits used to calculate the multiplicative inverse from the data qubits, to |0>.

The one or more processors may be configured to perform the field inverse transformation on the composite field into the finite field by multiplying a determinant corresponding to the result of calculation of the multiplicative inverse by a preset field inverse transformation determinant.

The one or more processors may be configured to perform the affine transformation using an affine transformation circuit configured using a Controlled Not (CNOT) gate and an X gate.

In accordance with another aspect of the present disclosure to accomplish the above objects, there is provided a cryptographic operation method using a quantum circuit, the cryptographic operation method being performed by a cryptographic operation apparatus using the quantum circuit, the cryptographic operation method including allocating input data corresponding to a finite field for calculating a substitution box to qubits; performing a field transformation on the input data allocated to the qubits from a finite field into data qubits corresponding to a composite field; setting auxiliary qubits corresponding to the data qubits; calculating a multiplicative inverse for the data qubits using the data qubits and the auxiliary qubits; performing a field inverse transformation on a result of calculation of the multiplicative inverse into a finite field; and outputting a result of calculation of the substation box from a result of calculation of the field inverse transformation through affine transformation.

Performing the field transformation may include performing the field transformation on the finite field into the composite field by multiplying a determinant corresponding to the finite field by a preset field transformation determinant.

The cryptographic operation method may further include initializing remaining auxiliary qubits, other than output qubits, among auxiliary qubits used to calculate the multiplicative inverse from the data qubits, to |0>.

Performing the field inverse transformation may include performing the field inverse transformation on the composite field into the finite field by multiplying a determinant corresponding to the result of calculation of the multiplicative inverse by a preset field inverse transformation determinant.

Outputting the result of calculation of the substation box may include performing the affine transformation using an affine transformation circuit configured using a Controlled Not (CNOT) gate and an X gate.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is an operation flowchart illustrating a cryptographic operation method using a quantum circuit according to an embodiment of the present disclosure;

FIG. 2 is a diagram illustrating a cryptographic operation apparatus using a quantum circuit according to an embodiment of the present disclosure; and

FIG. 3 is a diagram illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Hereinafter, embodiments of the present disclosure will be described in detail with reference to the attached drawings.

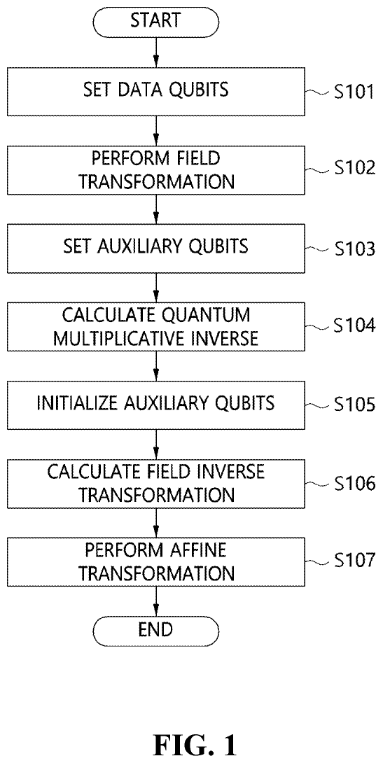

FIG. 1 is an operation flowchart illustrating a cryptographic operation method using a quantum circuit according to an embodiment of the present disclosure.

Referring to FIG. 1, in order to implement the cryptographic operation method using a quantum circuit according to the embodiment of the present disclosure, the substitution box (S-box) of an Advanced Encryption Standard (AES) algorithm may be implemented using a quantum circuit.

The multiplicative inverse in a finite field (or Galois field) GF(2⁸) may be implemented using a quantum circuit in a composite field GF(((2²)²)²), and thereafter an efficient quantum circuit may be implemented through suitable arrangement thereof.

The cryptographic operation method using a quantum circuit according to the embodiment of the present disclosure may provide a quantum S-box calculation method in GF(2⁸).

Generally, the S-box may take several input bits m and transform the input bits m into the number of some output bits n. Here, n is not necessarily equal to m. m×n S-box may be implemented as a lookup table with 2^{m} words of n bits each.

First, at step S101, qubits may be set in input data.

That is, at step S101, input data corresponding to a finite field for S-box calculation may be allocated to eight qubits.

Here, each of the qubits may have the state of |0> or |1> depending on the input value.

Further, at step S102, a field transformation may be performed.

That is, at step S102, the input data allocated to the qubits may be transformed from the finite field GF(2) into the composite field GF(((2²)²)²) using a preset field transformation determinant.

The field transformation determinant may be represented by the following Equation (1):

$$[ \begin{matrix}1 & 1 & 0 & 0 & 0 & 0 & 1 & 0 \\ 0 & 1 & 0 & 0 & 1 & 0 & 1 & 0 \\ 0 & 1 & 1 & 1 & 1 & 0 & 0 & 1 \\ 0 & 1 & 1 & 0 & 0 & 0 & 1 & 1 \\ 0 & 1 & 1 & 1 & 0 & 1 & 0 & 1 \\ 0 & 0 & 1 & 1 & 0 & 1 & 0 & 1 \\ 0 & 1 & 1 & 1 & 1 & 0 & 1 & 1 \\ 0 & 0 & 0 & 0 & 0 & 1 & 0 & 1\end{matrix} ] [ \begin{matrix}{q}_{0} \\ {q}_{1} \\ {q}_{2} \\ {q}_{3} \\ {q}_{4} \\ {q}_{5} \\ {q}_{6} \\ {q}_{7}\end{matrix} ] = [ \begin{matrix}{k}_{0} \\ {k}_{1} \\ {k}_{2} \\ {k}_{3} \\ {k}_{4} \\ {k}_{5} \\ {k}_{6} \\ {k}_{7}\end{matrix} ] \qquad ( 1 )$$

An irreducible polynomial used for the composite field may be represented by the following Equation (2):

$$\{ \begin{matrix}G F ( 2 ) ⇒ GF ( {2}^{2} ) , & {P}_{0} ( x ) = {x}^{2} + x + 1 \\ GF ( {2}^{2} ) ⇒ GF ( {( 2 )}^{2} ) , & {P}_{1} ( x ) = {x}^{2} + x + ϕ \\ G F ( {( {2}^{2} )}^{2} ) ⇒ GF ( {( {( {2}^{2} )}^{2} )}^{2} ) , & {P}_{2} ( x ) = {x}^{2} + x + λ\end{matrix} \qquad ( 2 )$$

In Equation (2), ϕ={10}₂ and λ={1100}₂ are satisfied.

At step S103, auxiliary qubits may be set.

That is, at step S103, the auxiliary qubits required for obtaining the results of S-box transformation for eight data qubits may be set. Some of the auxiliary qubits may be used as output qubits.

At step S104, a quantum multiplicative inverse may be calculated.

That is, at step S104, the multiplicative inverse for the data qubits may be calculated using the data qubits and the auxiliary qubits, and the results of calculation may be output.

At step S105, the auxiliary qubits may be initialized.

That is, at step S105, among the auxiliary qubits used to calculate the quantum multiplicative inverse from the data qubits, the remaining auxiliary qubits other than the output qubits may be initialized to |0>.

Further, at step S106, a field inverse transformation may be calculated.

At step S106, the result of the multiplicative inverse calculated in the composite field GF(((2²)²)²) may be transformed into the finite field GF(2⁸) using a preset field inverse transformation determinant. The field inverse transformation determinant may be represented by the following Equation (3):

$$[ \begin{matrix}1 & 0 & 1 & 0 & 1 & 1 & 1 & 0 \\ 0 & 0 & 0 & 0 & 1 & 1 & 0 & 0 \\ 0 & 1 & 1 & 1 & 1 & 0 & 0 & 1 \\ 0 & 1 & 1 & 1 & 1 & 1 & 0 & 0 \\ 0 & 1 & 1 & 0 & 1 & 1 & 1 & 0 \\ 0 & 1 & 0 & 0 & 0 & 1 & 1 & 0 \\ 0 & 0 & 1 & 0 & 0 & 0 & 1 & 0 \\ 0 & 1 & 0 & 0 & 0 & 1 & 1 & 1\end{matrix} ] [ \begin{matrix}{q}_{0} \\ {q}_{1} \\ {q}_{2} \\ {q}_{3} \\ {q}_{4} \\ {q}_{5} \\ {q}_{6} \\ {q}_{7}\end{matrix} ] = [ \begin{matrix}{k}_{0} \\ {k}_{1} \\ {k}_{2} \\ {k}_{3} \\ {k}_{4} \\ {k}_{5} \\ {k}_{6} \\ {k}_{7}\end{matrix} ] \qquad ( 3 )$$

At step S107, an affine transformation may be performed.

That is, at step S107, the result of the S-box transformation in AES for the input qubits may be calculated using the output result of calculation of the multiplicative inverse.

An affine transformation circuit configured using a Controlled Not (CNOT) gate and an X gate may be implemented such that a new matrix obtained using Equation (2) and the operation of the affine transformation matrix is configured using a CNOT gate in order to improve efficiency.

The determinant for the affine transformation may be represented by the following Equation (4):

$$[ \begin{matrix}1 & 0 & 0 & 0 & 1 & 1 & 1 & 1 \\ 1 & 1 & 0 & 0 & 0 & 1 & 1 & 1 \\ 1 & 1 & 1 & 0 & 0 & 0 & 1 & 1 \\ 1 & 1 & 1 & 1 & 0 & 0 & 0 & 1 \\ 1 & 1 & 1 & 1 & 1 & 0 & 0 & 0 \\ 0 & 1 & 1 & 1 & 1 & 1 & 0 & 0 \\ 0 & 0 & 1 & 1 & 1 & 1 & 1 & 0 \\ 0 & 0 & 0 & 1 & 1 & 1 & 1 & 1\end{matrix} ] [ \begin{matrix}{b}_{0} \\ {b}_{1} \\ {b}_{2} \\ {b}_{3} \\ {b}_{4} \\ {b}_{5} \\ {b}_{6} \\ {b}_{7}\end{matrix} ] + [ \begin{matrix}1 \\ 1 \\ 0 \\ 0 \\ 0 \\ 1 \\ 1 \\ 0\end{matrix} ] = [ \begin{matrix}{s}_{0} \\ {s}_{1} \\ {s}_{2} \\ {s}_{3} \\ {s}_{4} \\ {s}_{5} \\ {s}_{6} \\ {s}_{7}\end{matrix} ] \qquad ( 4 )$$

In Equation (4), [b0 to b7] is the result of calculation of the multiplicative inverse in the finite field GF(2⁸).

In the present disclosure, the multiplicative inverse for S-box calculation is calculated in the composite field GF(((2²)²)²), and thus Equation (4) may be represented by the following Equation (5):

$$[ \begin{matrix}1 & 0 & 0 & 0 & 1 & 1 & 1 & 1 \\ 1 & 1 & 0 & 0 & 0 & 1 & 1 & 1 \\ 1 & 1 & 1 & 0 & 0 & 0 & 1 & 1 \\ 1 & 1 & 1 & 1 & 0 & 0 & 0 & 1 \\ 1 & 1 & 1 & 1 & 1 & 0 & 0 & 0 \\ 0 & 1 & 1 & 1 & 1 & 1 & 0 & 0 \\ 0 & 0 & 1 & 1 & 1 & 1 & 1 & 0 \\ 0 & 0 & 0 & 1 & 1 & 1 & 1 & 1\end{matrix} ] [ \begin{matrix}1 & 0 & 1 & 0 & 1 & 1 & 1 & 0 \\ 0 & 0 & 0 & 0 & 1 & 1 & 0 & 0 \\ 0 & 1 & 1 & 1 & 1 & 0 & 0 & 1 \\ 0 & 1 & 1 & 1 & 1 & 1 & 0 & 0 \\ 0 & 1 & 1 & 0 & 1 & 1 & 1 & 0 \\ 0 & 1 & 0 & 0 & 0 & 1 & 1 & 0 \\ 0 & 0 & 1 & 0 & 0 & 0 & 1 & 0 \\ 0 & 1 & 0 & 0 & 0 & 1 & 1 & 1\end{matrix} ] [ \begin{matrix}{α}_{0} \\ {α}_{1} \\ {α}_{2} \\ {α}_{3} \\ {α}_{4} \\ {α}_{5} \\ {α}_{6} \\ {α}_{7}\end{matrix} ] + [ \begin{matrix}1 \\ 1 \\ 0 \\ 0 \\ 0 \\ 1 \\ 1 \\ 0\end{matrix} ] = [ \begin{matrix}{s}_{0} \\ {s}_{1} \\ {s}_{2} \\ {s}_{3} \\ {s}_{4} \\ {s}_{5} \\ {s}_{6} \\ {s}_{7}\end{matrix} ] \qquad ( 5 )$$

In Equation (5), [a0 to a7] denotes the multiplicative inverse calculated in the composite field GF(((2²)²)²).

Here, at step S107, after the multiplicative inverse calculated in the composite field GF(((2²)²)²) is transformed into the finite field GF(2⁸), the S-box transformation value may be obtained through an affine transformation.

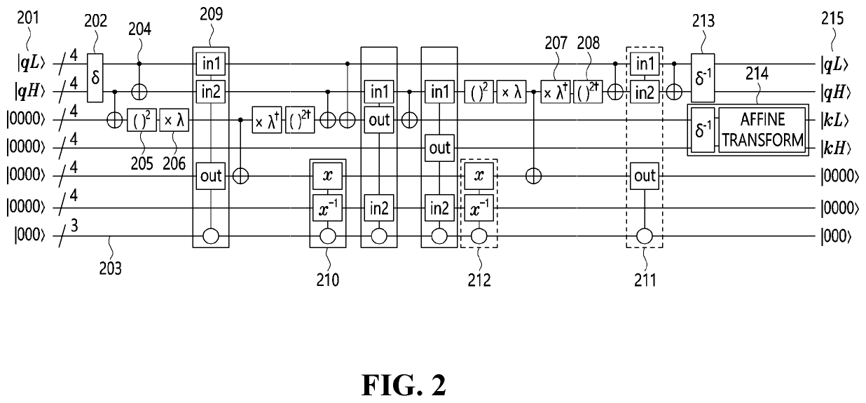

FIG. 2 is a diagram illustrating a cryptographic operation apparatus using a quantum circuit according to an embodiment of the present disclosure.

Referring to FIG. 2, the cryptographic operation apparatus using a quantum circuit according to the embodiment of the present disclosure may include a quantum multiplicative inverse calculator circuit (e.g., a S-box calculator implemented using a quantum circuit), which outputs a multiplicative inverse for eight qubits using a multiplicative inverse calculator in GF(2⁸).

As illustrated in FIG. 2, it can be seen that the input data is allocated to eight qubits, and auxiliary qubits are allocated to 19 qubits.

The uppermost line of a qubit register 203 refers to register 0, and a number corresponding to ‘/’ refers to the number of qubits represented by one line.

A field transformation unit 202 may transform eight data qubits from the finite field GF(2⁸) into a composite field GF(((2²)²)²).

A Controlled Not (CNOT) gate 204 may perform an addition operation, and sequentially connect four qubits to next four qubits.

A squaring operation unit 205 may perform a squaring operation in GF((2²)²), and λ={1100}₂ may be configured using four qubits. In the present disclosure, two squaring operation units may also be used.

A constant multiplication unit 206 performs a constant multiplication in GF((2²)²), and is configured using four qubits. In the present disclosure, two constant multiplication units may also be used.

A constant multiplication dagger calculation unit 207 may perform a dagger operation for a constant multiplication in GF (2²). The dagger calculation for a constant multiplication may transform the result of the constant multiplication into a state before multiplication.

Here, similar to the constant multiplication unit 206, the constant multiplication dagger calculation unit 207 may be configured using four qubits. In the present disclosure, two constant multiplication dagger calculation units may be used.

A squaring operation dagger calculation unit 208 may perform a dagger calculation for a squaring operation in GF((2²)²). The dagger calculation for the squaring operation may transform the result of a squaring operation into a state before the squaring operation.

Similar to the squaring operation unit 205, the squaring operation dagger calculation unit 208 may be configured using four qubits. In the present disclosure, two squaring operation dagger calculation units may be used.

A quantum multiplication unit 209 may perform a quantum multiplication in GF((2²)²) .

Here, the quantum multiplication unit 209 may perform a multiplication on two 4-qubit inputs, and may be configured using eight input qubits, four output qubits, and three auxiliary qubits. In the present disclosure, three quantum multiplication units may be used.

A quantum multiplicative inverse calculation unit 210 may perform calculation of quantum multiplicative inverse in GF((2²)²).

Here, the quantum multiplicative inverse calculation unit 210 may output a quantum multiplicative inverse for four input qubits.

The quantum multiplicative inverse calculation unit 210 may be configured using four input qubits, four output qubits, and three auxiliary qubits.

A quantum multiplication dagger calculation unit 211 may perform a dagger calculation for quantum multiplication in GF((2²)²), and may initialize qubits to which the output of multiplication on eight input qubits is allocated.

A quantum multiplicative inverse dagger calculation unit 212 may perform a dagger calculation for quantum multiplicative inverse in GF((2²)²), and may initialize qubits to which the quantum multiplicative inverse is allocated.

A field inverse transformation circuit unit 213 may transform input, which is transformed into a composite field GF(((2²)²)²), into a finite field GF(2⁸).

An affine transformation unit 214 may connect the field inverse transformation circuit to an affine transformation circuit, may transform the multiplicative inverse calculated in the composite field GF(((2²)²)²) into a finite field GF(2⁸), and may output the result of an S-box transformation through affine transformation.

The affine transformation unit 214 may calculate, in advance, a field inverse transformation process and an affine transformation process, as shown in Equation (5), so as to configure an efficient quantum circuit, and thereafter configure a quantum circuit.

It can be seen that output data 215 may indicate the states of output qubits. Among 19 auxiliary qubits, eight qubits are used to output the results of S-box transformation, and all of the remaining 11 auxiliary qubits may be initialized to |0>.

The cryptographic operation apparatus and method using a quantum circuit according to an embodiment of the present disclosure are intended to present in detail an efficient quantum S-box configuration method, and the locations of qubits configuring the quantum S-box circuit provided in the embodiment may be changed. Therefore, those skilled in the art will appreciate that various modifications and other equivalent embodiments may be implemented from the descriptions thereof.

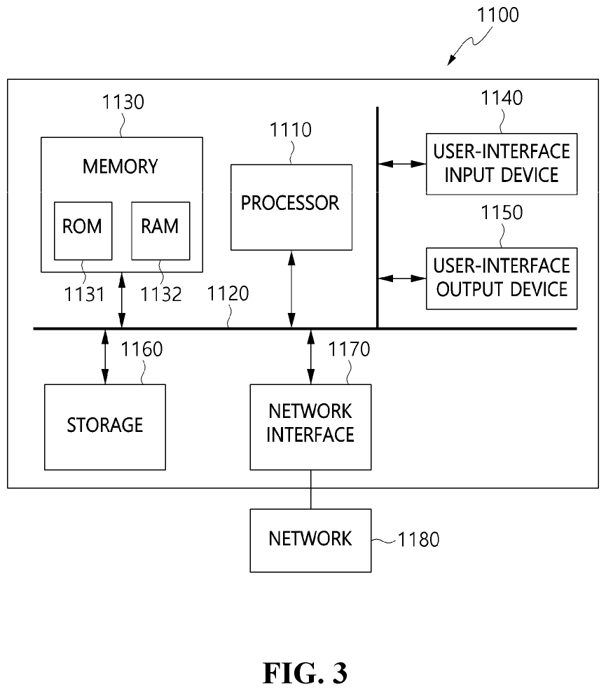

FIG. 3 is a diagram illustrating a computer system according to an embodiment of the present disclosure.

Referring to FIG. 3, a cryptographic operation apparatus using a quantum circuit according to an embodiment of the present disclosure may be implemented in a computer system 1100, such as a computer-readable storage medium. As illustrated in FIG. 3, the computer system 1100 may be configured using a quantum computer (or Quantum Computing and Quantum Information Processing. (QC/QIP) system), a classical computer, or a combination of quantum and a classical computing function. For example, the computer system 1100 may implement some or all of the characteristics described in the present specification in relation to software-defined quantum computers including modular scalability, architecture, resource manager function, workflow, application programming interface (API) access point, and exception categories/handling. Here, the classical computer may implement the present disclosure in a quantum simulator form. Further, the computer system 1100 may implement the characteristics of a classical computer so as to perform a specific function such as compiling or optimization. Furthermore, the computer system 1100 may sequentially and/or simultaneously implement combinations of the characteristics of a classical computer and a quantum computer so as to implement various characteristics described in the present specification.

The function of the quantum computer does not need to be restricted or limited by hardware design, and may be configured using software. By implementing a software-defined architecture for the quantum computer, a qubit system may be defined using software or some dynamic instructions, qubit connections (e.g., connection between different qubits) may be controlled and manipulated, inter-qubit connection (e.g., interaction between different qubits) may be modulated, and given computation or simulation tasks may be executed. This approach includes a systematic method for describing hardware configuration of the quantum computer.

The quantum computer (or QC/QIP system) may handle quantum data (measured in units of qubit), and thus data paths must be configured as quantum objects. A functional unit for storing, transmitting, and handling data must process qubits, maintain quantum characteristics (e.g., overlapping or closely related thereto), and simultaneously act on all components in an input-overlap state. In contrast, because a command specified in a control program is essentially classical, a control unit may typically be classical. A typical control unit may be configured to transform a command from a program or an algorithm into a classical control signal for operating a functional unit so that the command acts on qubits to influence desired data handling. Action on qubits is generally taken in an analog form, and the classical control signal (generally configured using carrier electromagnetic fields, such as radio frequency (RF) waves, microwaves, or optical waves, typically having modulation of encoding actions of identical or individual fields) is used to transform qubits (or qubit groups) into other quantum states through time-evolution of the quantum system. That is, the classical control signal is used to sequentially transform qubit states over time and control an operation of performing desired computation or generating simulation.

The implementation of a quantum computer (or QC/QIP system) is characterized in that a control unit is designed and configured in detail using hardware, whereas physical implementation of data paths is considered to be completely flexible and reconfigurable. The physical implementation of the data paths is described as a series of commands provided to a hardware device without designing in advance in hardware or being produced in hardware. Similarly, interaction between qubit data paths may be implemented as a series of commands defining time evolution of a qubit system instructed by a control signal generated by the control unit using a software program.

The computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing processing instructions stored in the memory 1130 or the storage 1160.

Here, each processor 1110 may include a single processor, or multiple processor sets, or a multi-core processor. Also, the processor 1110 may be implemented as an integrated processing system and/or a distributed processing system.

Each processor 1110 may include either or both of a Central Processing Unit (CPU) and a Quantum Processing Unit (QPU). In this way, the processor 1110 may be used to perform or implement a classical operation, a quantum operation, or a combination thereof.

The processor 1110 may control qubits while executing at least some of a program, an API, and/or the Quality of Service (QOS) by implementing, for example, at least some of a control unit, a communication control unit, and/or a switch/router unit.

Each of the memory 1130 and the storage 1160 may be any of various types of volatile or nonvolatile storage media. For example, the memory 1130 may include Read-Only Memory (ROM) 1131 or Random Access Memory (RAM) 1132.

Furthermore, the computer system 1100 according to an embodiment of the present disclosure may include qubit hardware when implementing the characteristics of a quantum computer or a QC/QIP system. The qubit hardware may be based on one type of quantum technology such as ion-trap technology, wherein the qubit hardware includes at least one ion trap for performing a quantum operation. The qubit hardware may be based on another type of quantum technology such as superconductivity technology, wherein the qubit hardware includes a superconductivity circuit for performing a quantum operation.

Furthermore, the cryptographic operation apparatus using a quantum circuit according to an embodiment of the present disclosure includes one or more processors 1110 and execution memory 1130 configured to store at least one program that is executed by the one or more processors, wherein the one or more processors 1110 are configured to allocate input data corresponding to a finite field for calculating a substitution box to qubits, perform a field transformation on the input data allocated to the qubits from a finite field into data qubits corresponding to a composite field, set auxiliary qubits corresponding to the data qubits, calculate a multiplicative inverse for the data qubits using the data qubits and the auxiliary qubits, perform a field inverse transformation on a result of calculation of the multiplicative inverse into a finite field, and output a result of calculation of the substation box from a result of calculation of the field inverse transformation through affine transformation.

Here, the one or more processors 1110 may be configured to perform the field transformation on the finite field into the composite field by multiplying a determinant corresponding to the finite field by a preset field transformation determinant.

Here, the one or more processors 1110 may be configured to initialize remaining auxiliary qubits, other than output qubits, among auxiliary qubits used to calculate the multiplicative inverse from the data qubits, to |0>.

Here, the one or more processors 1110 may be configured to perform the field inverse transformation on the composite field into the finite field by multiplying a determinant corresponding to the result of calculation of the multiplicative inverse by a preset field inverse transformation determinant.

Here, the one or more processors 1110 may be configured to perform the affine transformation using an affine transformation circuit configured using a Controlled Not (CNOT) gate and an X gate.

The present disclosure may implement a quantum circuit that uses fewer qubits to apply a quantum computation algorithm to an AES.

Further, the present disclosure may reduce quantum resources required for a cryptographic operation using fewer qubits.

As described above, in the cryptographic operation apparatus and method using a quantum circuit according to the present disclosure, the configurations and schemes in the above-described embodiments are not limitedly applied, and some or all of the above embodiments can be selectively combined and configured so that various modifications are possible.

What is claimed is:

1. A cryptographic operation apparatus using a quantum circuit, comprising:
one or more processors; and
an execution memory configured to store at least one program that is executed by the one or more processors,
wherein the one or more processors are configured to:
allocate input data corresponding to a finite field for calculating a substitution box to qubits,
perform a field transformation on the input data allocated to the qubits from a finite field into data qubits corresponding to a composite field,
set auxiliary qubits corresponding to the data qubits,
calculate a multiplicative inverse for the data qubits using the data qubits and the auxiliary qubits,
perform a field inverse transformation on a result of calculation of the multiplicative inverse into a finite field, and
output a result of calculation of the substation box from a result of calculation of the field inverse transformation through affine transformation.

2. The cryptographic operation apparatus of claim 1, wherein the one or more processors are configured to perform the field transformation on the finite field into the composite field by multiplying a determinant corresponding to the finite field by a preset field transformation determinant.

3. The cryptographic operation apparatus of claim 2, wherein the one or more processors are configured to initialize remaining auxiliary qubits, other than output qubits, among auxiliary qubits used to calculate the multiplicative inverse from the data qubits, to |0>.

4. The cryptographic operation apparatus of claim 3, wherein the one or more processors are configured to perform the field inverse transformation on the composite field into the finite field by multiplying a determinant corresponding to the result of calculation of the multiplicative inverse by a preset field inverse transformation determinant.

5. The cryptographic operation apparatus of claim 1, wherein the one or more processors are configured to perform the affine transformation using an affine transformation circuit configured using a Controlled Not (CNOT) gate and an X gate.

6. A cryptographic operation method using a quantum circuit, the cryptographic operation method being performed by a cryptographic operation apparatus using the quantum circuit, the cryptographic operation method comprising:
allocating input data corresponding to a finite field for calculating a substitution box to qubits;
performing a field transformation on the input data allocated to the qubits from a finite field into data qubits corresponding to a composite field;
setting auxiliary qubits corresponding to the data qubits;
calculating a multiplicative inverse for the data qubits using the data qubits and the auxiliary qubits;
performing a field inverse transformation on a result of calculation of the multiplicative inverse into a finite field; and
outputting a result of calculation of the substation box from a result of calculation of the field inverse transformation through affine transformation.

7. The cryptographic operation method of claim 6, wherein performing the field transformation comprises:
performing the field transformation on the finite field into the composite field by multiplying a determinant corresponding to the finite field by a preset field transformation determinant.

8. The cryptographic operation method of claim 7, further comprising:
initializing remaining auxiliary qubits, other than output qubits, among auxiliary qubits used to calculate the multiplicative inverse from the data qubits, to |0>.

9. The cryptographic operation method of claim 8, wherein performing the field inverse transformation comprises:
performing the field inverse transformation on the composite field into the finite field by multiplying a determinant corresponding to the result of calculation of the multiplicative inverse by a preset field inverse transformation determinant.

10. The cryptographic operation method of claim 6, wherein outputting the result of calculation of the substation box comprises:
performing the affine transformation using an affine transformation circuit configured using a Controlled Not (CNOT) gate and an X gate.
